(19) United States
(12) Patent Application Publication
(10) Pub. No.: US 2020/0171815 A1
(43) Pub. Date: Jun. 4, 2020

(54) IMAGE FORMING APPARATUS, IMAGE FORMING SYSTEM, IMAGE FORMING METHOD, AND NON-TRANSITORY RECORDING MEDIUM

(71) Applicants: Yoshimichi KANDA, Kanagawa (JP); Yosuke FUKUDA, Kanagawa (JP); Masashi NAKAMURA, Chiba (JP)

(72) Inventors: Yoshimichi KANDA, Kanagawa (JP); Yosuke FUKUDA, Kanagawa (JP); Masashi NAKAMURA, Chiba (JP)

(73) Assignee: Ricoh Company, Ltd., Tokyo (JP)

(21) Appl. No.: 16/671,390

(22) Filed: Nov. 1, 2019

(30) Foreign Application Priority Data
Nov. 30, 2018 (JP) 2018-225838
Sep. 25, 2019 (JP) 2019-174372

(51) Int. Cl. B41J 2/045; B41J 2/21; B41J 2/14

(52) U.S. Cl. CPC B41J 2/0451; B41J 2/2139; B41J 2202/20; B41J 2/14; B41J 2202/13; B41J 2/2142

(57) ABSTRACT

An image forming apparatus includes circuitry and print heads each including nozzles arranged along a main scanning direction. The print heads are arranged in rows along a sub-scanning direction, with a print head in a first row overlapping a print head in a second row. The circuitry executes control to perform printing with at least one of the print head in the first row and the print head in the second row, executes control to eject recording liquid from nozzles in a non-overlapping area of the print head in the first row and the print head in the second row, selects an ejection area from an overlapping area of the print head in the first row and the print head in the second row, and executes control to eject the recording liquid from one of two nozzles adjacent in the sub-scanning direction in the ejection area.

### CROSS-REFERENCE TO RELATED APPLICATION

This patent application is based on and claims priority pursuant to 35 U.S.C. § 119(a) to Japanese Patent Application Nos. 2018-225838 filed on Nov. 30, 2018, 2019-174372 filed on Sep. 25, 2019, in the Japan Patent Office, the entire disclosure of which is hereby incorporated by reference herein.

### BACKGROUND

### Technical Field

The present invention relates to an image forming apparatus, an image forming system, an image forming method, and a non-transitory recording medium.

### Description of the Related Art

There is an existing technique of correcting a pixel corresponding to a defective ejection nozzle having defective ink ejection in an inkjet image printing apparatus, to thereby reduce the influence of the defective ejection nozzle on the image formed by the image printing apparatus.

For example, there is an image forming apparatus that detects and corrects the defective ejection on-line during a printing operation or during the interval between forming one image and forming the next image, for example. The image forming apparatus determines the defective ejection of the nozzle from an ink flow speed in a nozzle tube detected based on a voltage generated from a coil disposed in each of nozzles of a print head supplied with charged ink.

The image forming apparatus further corrects the ejection by changing the flying direction of ink ejected from a nozzle adjacent to the defective ejection nozzle toward the ink ejection direction of the defective ejection nozzle, to thereby reduce the influence of the defective ejection nozzle on the image formed by the image printing apparatus.

However, the image formed with the nozzle adjacent to the defective ejection nozzle to compensate for a deficit in print density due to the defective ejection nozzle may be lower in quality than the image formed during normal operation of the defective ejection nozzle (i.e., the image formed before the occurrence of defective ejection in the defective ejection nozzle).

### SUMMARY

In one embodiment of this invention, there is provided an improved image forming apparatus that includes, for example, a print head group and circuitry. The print head group includes a plurality of print heads each including a plurality of nozzles arranged along a main scanning direction. The plurality of print heads are arranged in a plurality of rows along a sub-scanning direction perpendicular to the main scanning direction, with a print head in a first row of the plurality of rows overlapping, in the sub-scanning direction, a print head in a second row of the plurality of rows adjacent to the first row. The circuitry controls the print head group to perform printing with at least one of the print head in the first row and the print head in the second row arranged along the sub-scanning direction, controls the print head group to eject recording liquid from a plurality of nozzles in a non-overlapping area of the print head in the first row and the print head in the second row not overlapping in the sub-scanning direction, selects a recording liquid ejection area from an overlapping area of the print head in the first row and the print head in the second row overlapping in the sub-scanning direction, and controls the print head group to eject the recording liquid from one nozzle of two adjacent nozzles adjacent to each other in the sub-scanning direction in the selected recording liquid ejection area.

In one embodiment of this invention, there is provided an improved image forming system that includes, for example, the above-described image forming apparatus and a data converting device. The data converting device receives print data from an information processing device, converts the received print data into data in a data format compatible with the image forming apparatus, and supplies the converted data to the image forming apparatus.

In one embodiment of this invention, there is provided an improved image forming method of forming an image with a print head group. The print head group includes a plurality of print heads each including a plurality of nozzles arranged along a main scanning direction. The plurality of print heads are arranged in a plurality of rows along a sub-scanning direction perpendicular to the main scanning direction, with a print head in a first row of the plurality of rows overlapping, in the sub-scanning direction, a print head in a second row of the plurality of rows adjacent to the first row. The image forming method includes, for example, controlling the print head group to perform printing with at least one of the print head in the first row and the print head in the second row arranged along the sub-scanning direction, controlling the print head group to eject recording liquid from a plurality of nozzles in a non-overlapping area of the print head in the first row and the print head in the second row not overlapping in the sub-scanning direction, selecting a recording liquid ejection area from an overlapping area of the print head in the first row and the print head in the second row overlapping in the sub-scanning direction, and controlling the print head group to eject the recording liquid from one nozzle of two adjacent nozzles adjacent to each other in the sub-scanning direction in the selected recording liquid ejection area.

In one embodiment of this invention, there is provided a non-transitory recording medium storing a plurality of instructions which, when executed by one or more processors, cause the processors to perform the above-described image forming method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a sectional view of components of an image forming apparatus included in an image forming system of an embodiment of the present invention;

FIG. 2 is a diagram illustrating arrangement of nozzles included in each of heads of the image forming apparatus;

FIG. 3 is a system configuration diagram of the image forming system of the embodiment;

FIG. 4 is a block diagram of an image converting device included in the image forming apparatus to convert image data transmitted from a digital front end device into data for each of print heads;

FIG. 5 is a functional block diagram of an application specific integrated circuit of the image converting device;

FIG. 6 is a schematic diagram illustrating a procedure of a head data conversion process of the embodiment based on defective ejection nozzle detection information;

FIGS. 7A and 7B are diagrams illustrating the relationship between mask nozzles and data conversion by a head data converting unit of the application specific integrated circuit;

FIG. 8 is a flowchart illustrating a procedure of a process of the embodiment from detection of a defective ejection nozzle to generation of head output data by the head data converting unit;

FIG. 9 is a diagram illustrating mask pixel setting of the embodiment according to the position of the defective ejection nozzle;

FIG. 10 is a diagram illustrating a registering unit that holds setting values of mask pixels;

FIG. 11 is a diagram illustrating a modified example of the mask pixel setting of the embodiment according to the position of the defective ejection nozzle; and

FIG. 12 is a sectional view of components of an image forming apparatus included in an image forming system of an embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of an image forming apparatus, an image forming system, an image forming method, and a non-transitory recording medium of the present invention will be described below with reference to the accompanying drawings.

A configuration of an image forming apparatus according to embodiments of the present invention will be described.

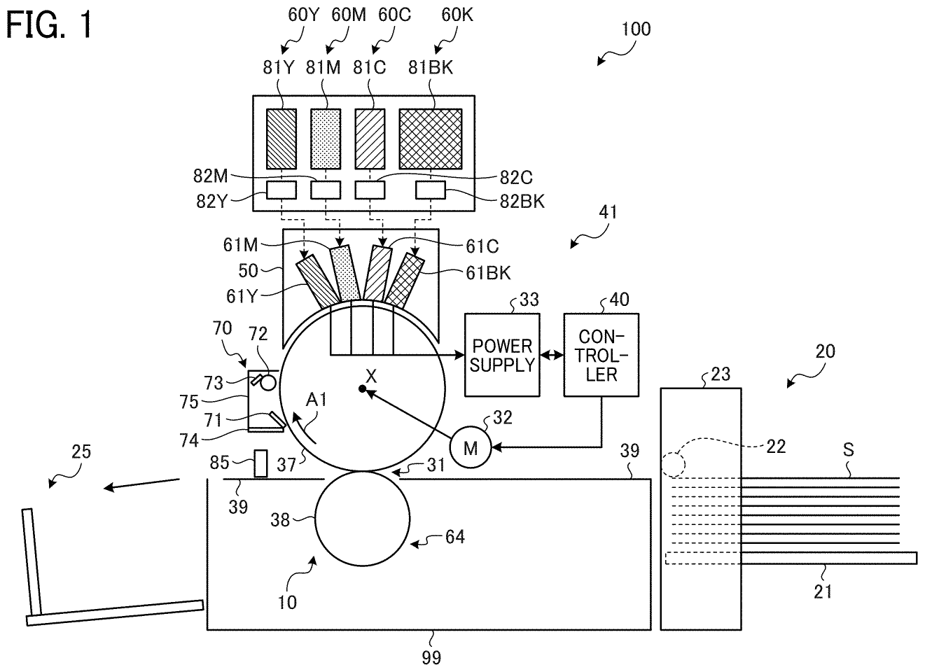

FIG. 1 is a sectional view of components of an image forming apparatus 100 included in an image forming system according to an embodiment. For example, the image forming apparatus 100 is an inkjet printer capable of forming a full-color image. The image forming apparatus 100 performs an image forming process based on image information received from outside the image forming apparatus 100.

The image forming apparatus 100 is capable of forming an image on a sheet-shaped recording medium, which includes an overhead projector (OHP) sheet, thick paper such as a card or a postcard, and an envelope, as well as plain paper typically used in copying. The following description will be given on the assumption that the image forming apparatus 100 is a simplex image forming apparatus capable of forming an image on one side of a transfer sheet S as the recording medium. The image forming apparatus 100, however, may be a duplex image forming apparatus capable of forming images on both sides of the transfer sheet S.

The image forming apparatus 100 includes heads 61Y, 61M, 61C, and 61BK that eject conductive recording liquid (e.g., ink) for forming a yellow image, a magenta image, a cyan image, and a black (or key plate) image, respectively. The heads 61Y, 61M, 61C, and 61BK function as inkjet heads, which are recording heads that eject the recording liquid.

The heads 61Y, 61M, 61C, and 61BK are positioned facing the outer circumferential surface of an intermediate transfer member 37 disposed substantially at the center of a main unit 99 of the image forming apparatus 100. The heads 61Y, 61M, 61C, and 61BK are sequentially arranged side by side from the upstream side in direction A1 corresponding to the moving direction of the intermediate transfer member 37, i.e., the clockwise direction in FIG. 1. In FIG. 1, suffixes Y, M, C, and BK following reference numerals indicate that respective components corresponding to the suffixes Y, M, C, and BK are used for forming the yellow image, the magenta image, the cyan image, and the black image, respectively.

The image forming apparatus 100 further includes ink ejection devices 60Y, 60M, 60C, and 60BK for forming the yellow image, the magenta image, the cyan image, and the black image, respectively. The heads 61Y, 61M, 61C, and 61BK are disposed in the ink ejection devices 60Y, 60M, 60C, and 60BK, respectively, such that the heads 61Y, 61M, 61C, and 61BK are arranged side by side, each extending along a main scanning direction X perpendicular to the drawing plane of FIG. 1.

During the rotation of the intermediate transfer member 37 in direction A1, the heads 61Y, 61M, 61C, and 61BK eject yellow recording liquid, magenta recording liquid, cyan recording liquid, and black recording liquid, respectively, onto the intermediate transfer member 37 such that the yellow recording liquid, the magenta recording liquid, the cyan recording liquid, and the black recording liquid are sequentially superimposed upon each other. Thereby, an intermediate image is formed on the outer circumferential surface of the intermediate transfer member 37. The image forming apparatus 100 thus has a tandem structure in which the heads 61Y, 61M, 61C, and 61BK are arranged side by side in direction A1, facing the intermediate transfer member 37.

The heads 61Y, 61M, 61C, and 61BK eject the recording liquid onto the intermediate transfer member 37 at different times from the upstream side to the downstream side in direction A1 such that a yellow image area, a magenta image area, a cyan image area, and a black image area are superimposed upon each other at the same position on the intermediate transfer member 37.

The image forming apparatus 100 further includes a transport device 10 and a sheet feeding device 20. The transport device 10 includes the intermediate transfer member 37 to transport the transfer sheet S with the rotation of the intermediate transfer member 37 in direction A1. The sheet feeding device 20 feeds the uppermost transfer sheet S on a stack of transfer sheets S toward the transport device 10.

The image forming apparatus 100 further includes a sheet ejection tray 25 and a cleaning device 70. The sheet ejection tray 25 is capable of receiving a stack of transfer sheets S each having an image formed (i.e., printed) thereon and transported by the transport device 10. The cleaning device 70 functions as a residual ink removing mechanism that removes, from the intermediate transfer member 37 after the transfer of the recording liquid therefrom to the transfer sheet S, residual ink (i.e., recording liquid) remaining on the intermediate transfer member 37.

The image forming apparatus 100 further includes a carriage 50 and a power supply 33. The carriage 50 functions as a head supporting member that integrally supports the heads 61Y, 61M, 61C, and 61BK. The power supply 33 applies a voltage to the recording liquid ejected from the heads 61Y, 61M, 61C, and 61BK.

The image forming apparatus 100 further includes a controller 40 that controls an overall operation of the image forming apparatus 100 and an operation panel including a display that displays information of various states of the image forming apparatus 100.

The transport device 10 includes a transfer device 64, a guide plate 39, and a motor 32, as well as the intermediate transfer member 37. The transfer device 64 is disposed facing the intermediate transfer member 37. When the transfer sheet S passes through a transfer area 31 between the intermediate transfer member 37 and the transfer device 64, the transfer device 64 transfers the image carried on the intermediate transfer member 37, i.e., the image formed with the recording liquid, onto the transfer sheet S. The transfer sheet S fed from the sheet feeding device 20 is transported to the transfer area 31 and ejected onto the sheet ejection tray 25 on the guide plate 39. The motor 32 drives the intermediate transfer member 37 to rotate in direction A1.

The thus-configured image forming apparatus 100 is an indirect image forming apparatus that indirectly forms an image on the transfer sheet S with the intermediate transfer member 37. The transfer device 64 includes a transfer roller 38 and a spring member. The transfer roller 38 is driven to rotate by the rotation of the intermediate transfer member 37. The spring member functions as a pressing device that presses the transfer roller 38 against the intermediate transfer member 37 such that the transfer roller 38 functions as a pressure roller. With this configuration, the transfer device 64 transports the transfer sheet S through the space between the intermediate transfer member 37 and the transfer roller 38 while applying pressure to the transfer sheet S.

The sheet feeding device 20 includes a sheet feeding tray 21, a sheet feeding roller 22, and a housing 23. The sheet feeding tray 21 is capable of storing a stack of transfer sheets S. The sheet feeding roller 22 feeds the uppermost transfer sheet S from the stack of transfer sheets S on the sheet feeding tray 2.1 toward the transport device 10. The housing 23 supports the sheet feeding tray 21 and the sheet feeding roller 22. The sheet feeding device 20 further includes a motor that drives the sheet feeding roller 22 to rotate and feed the transfer sheet S in appropriate timing with the ejection of the recording liquid from the heads 61Y, 61M, 61C, and 61BK.

The cleaning device 70 includes a blade 71, a roller 72, a blade 73, a waste liquid bottle 64, and a housing 75. The blade 71 is a cleaning blade that scrapes residual recording liquid off the outer circumferential surface of the intermediate transfer member 37. The residual recording liquid is residue of the recording liquid used to form the image on the intermediate transfer member 37 and left on the intermediate transfer member 37 without being transferred to the transfer sheet S. The roller 72 functions as a cleaning roller. The blade 73 comes into contact with the roller 72 to clean the roller 72. The waste liquid bottle 74 is a waste liquid tank for collecting the recording liquid and foreign substances such as dust, which are scraped off from the outer circumferential surface of the intermediate transfer member 37 by the blade 71 or the roller 72 and from the outer circumferential surface of the roller 72 by the blade 73.

The housing 75 houses the blade 71, the roller 72, the blade 73, and the waste liquid bottle 74. The housing 75 further supports the blades 71 and 73 to be positioned at respective predetermined positions, and rotatably supports the roller 72.

The cleaning device 70 further includes a pressing member that presses the blade 71 against the intermediate transfer member 37 and a motor that drives the roller 72 to rotate at a moving speed different from the moving speed of the outer circumferential surface of the intermediate transfer member 37.

The blade 71 is in counter-contact with the intermediate transfer member 37. The blade 71 is included in the cleaning device 70 as a first contact member that cleans the outer circumferential surface of the intermediate transfer member 37 by moving relative to the intermediate transfer member 37 when the intermediate transfer member 37 rotates in direction A1. The blade 71 is an elastic blade formed as an elastic body made of a material such as rubber. The material of the blade 71 may be an elastic material such as silicone rubber, nitrile rubber, urethane rubber, fluororubber, ethylene-propylene diene monomer (EPDM), or elastomer, a metal such as stainless steel or aluminum, or a non-ferrous material.

The roller 72 is included in the cleaning device 70 as a second contact member that cleans the outer circumferential surface of the intermediate transfer member 37 by moving relative to the intermediate transfer member 37 when driven by the above-described motor. The cleaning device 70 may include a plurality of rollers 72. The roller 72 extends along the main scanning direction X with the rotation axis thereof being parallel to the main scanning direction X, and is in contact with the intermediate transfer member 37.

The speed of rotation of the roller 72 by the motor is set to be different from the moving speed of the outer circumferential surface of the intermediate transfer member 37, as described above. This difference in speed is set as appropriate to a preferable value depending on the combination of the material of the outer circumferential surface of the intermediate transfer member 37 and the material of the outer circumferential surface of the roller 72. With the above-described relative movement, the blade 71 and the roller 72 clean the intermediate transfer member 37 by scrapping and removing, from the outer circumferential surface of the intermediate transfer member 37, the residual recording liquid such as liquid ink, paper dust transferred to the intermediate transfer member 37 from the transfer sheet S, and dust and other substances adhering to the intermediate transfer member 37.

Since the blade 71 and the roller 72 clean the outer circumferential surface of the intermediate transfer member 37 with the above-described relative movement, the blade 71 and the roller 72 may come into contact with the outer circumferential surface of the intermediate transfer member 37 at least when the relative movement occurs. The cleaning device 70 therefore may include a driving device that changes the positions of the blade 71 and the roller 72 and brings the blade 71 and the roller 72 into contact with the intermediate transfer member 37 when the relative movement occurs.

The blade 73 is in counter-contact with the roller 72. The blade 73 moves relative to the roller 72 to clean the outer circumferential surface of the roller 72. The waste liquid bottle 74 stores the substances collected as described above, such as the residual recording liquid (e.g., ink), the paper dust, and other types of dust falling from above after being removed from the outer circumferential surface of the intermediate transfer member 37 by the blade 71 or the roller 72 or from the outer circumferential surface of the roller 72 by the blade 73. Although it is desirable to drive the roller 72 at the above-described speed different from the speed of the outer circumferential surface of the intermediate transfer member 37, a drive source of the roller 72 may be omitted, and the roller 72 may be driven to rotate by the rotation of the intermediate transfer member 37. Further, the roller 72 may be omitted.

The carriage 50 is attachable to and detachable from the main unit 99 to enable replacement of the heads 61Y, 61M, 61C, and 61BK with new ones when the heads 61Y, 61M, 61C, and 61BK are degraded, and to facilitate maintenance work. The carriage 50 is integrally attachable to and detachable from the main unit 99 with the heads 61Y, 61M, 61C, and 61BK. Further, each of the heads 61Y, 61M, 61C, and 61BK is independently attachable to and detachable from the main unit 99 to enable replacement of each of the heads 61Y, 61M, 61C, and 61BK with a new one when the head 61Y, 61M, 61C, or 61BK is degraded, and to facilitate maintenance work. This configuration simplifies replacement work and maintenance work.

The ink ejection devices 60Y, 60M, 60C, and 60BK are substantially similar in configuration except for the difference in color of the recording liquid contained therein. The image forming apparatus 100 with the ink ejection devices 60Y, 60M, 60C, and 6013K is implemented as an image forming apparatus with a fixed, full-line head (i.e., a head fixedly installed in an image forming apparatus and having a length covering the entire width of the image forming area).

The ink ejection devices 60Y, 60M, 60C, and 60BK include ink cartridges 81Y, 81M, 81C, and 81BK and pumps 82Y, 82M, 82C, and 82BK, respectively. The ink cartridges 81Y, 81M, 81C, and 81BK store the yellow recording liquid, the magenta recording liquid, the cyan recording liquid, and the black recording liquid, respectively, which are supplied to the heads 61Y, 61M, 61C, and 61BK, respectively. The pumps 82Y, 82M, 82C, and 82BK send the recording liquid from the ink cartridges 81Y, 81M, 81C, and 81BK to the heads 61Y, 61M, 61C, and 61BK, respectively.

The ink cartridges 81Y, 81M, 81C, and 81BK function as recording liquid supplying devices that supply the recording liquid to the heads 61Y, 61M, 61C, and 61BK, respectively. Each of the ink cartridges 81Y, 81M, 81C, and 81BK is attachable to and detachable from the main unit 99 to be replaced with a new one when the recording liquid therein is consumed and runs short or out, and to facilitate maintenance work.

The ink cartridges 81Y, 81M, 81C, and 8113K are implemented as bag-shaped ink packs made of a soft plastic material such that the ink cartridges 81Y, 81M, 81C, and 81BK deflate with the consumption of the recording liquid therein. Alternatively, the ink cartridges 81Y, 81M, 81C, and 81BK may be made of a relatively rigid plastic material.

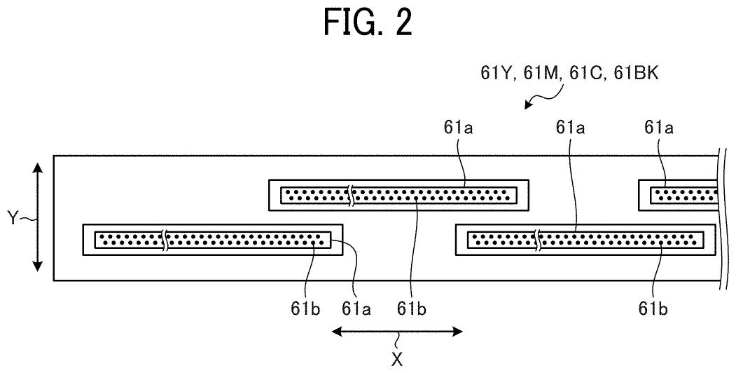

The controller 40 is implemented as circuitry functioning as an ejection control unit and a print control unit. The controller 40 supplies a voltage pulse having a predetermined signal waveform to each of piezoelectric elements of nozzles 61b in the heads 61Y, 61M, 61C, and 61BK, as illustrated in FIG. 2. The controller 40 drives the piezoelectric elements of the nozzles 61b in time series to form a desired pattern (i.e., image)with the recording liquid ejected from the nozzles 61b.

The pressure in the heads 61Y, 61M, 61C, and 61BK is kept negative except when the recording liquid is ejected (i.e., discharged) from the nozzles 61b. As an actuator for ejecting the recording liquid, a deformable element actuator such as a piezo-actuator or another type of movable actuator may be employed. Alternatively, the actuator for ejecting the recording liquid may be a thermal actuator that boils the recording liquid with a heater and ejects the boiled recording liquid from the nozzles 61b, or may he an actuator that applies a voltage to each of the nozzles 61b to eject the recording liquid therefrom with electrostatic attraction.

When the thus-configured image forming apparatus 100 receives input of a predetermined signal for instructing to start image formation, the intermediate transfer member 37 starts rotating in direction A1 while facing the heads 61Y, 61M, 61C, and 61BK. When the intermediate transfer member 37 is rotating in direction A1 while facing the heads 61Y, 61M, 61C, and 61BK, the heads 61Y, 61M, 61C, and 61BK eject the yellow recording liquid, the magenta recording liquid, the cyan recording liquid, and the black recording liquid, respectively.

The heads 61Y, 61M, 61C, and 61BK eject the yellow recording liquid, the magenta recording liquid, the cyan recording liquid, and the black recording liquid at different times from the upstream side to the downstream side in direction A1 such that the yellow image area, the magenta image area, the cyan image area, and the black image area are sequentially superimposed upon each other at the same position on the intermediate transfer member 37. Thereby, an image is temporarily carried on the intermediate transfer member 37.

The intermediate transfer member 37 thus functions as an image bearer that bears the image formed with the recording liquid ejected from the nozzles 61b. The sheet feeding device 20 feeds the transfer sheet S into the transfer area 31 in synchronization with the arrival of a leading edge of the image carried on the intermediate transfer member 37 to the transfer area 31. Thereby, the transfer roller 38 is driven to rotate, and the image carried on the intermediate transfer member 37 is transferred onto the transfer sheet S passing through the transfer area 31, forming an image on a surface of the transfer sheet S. The transfer sheet S with the image formed thereon is ejected onto the sheet ejection tray 25.

To read the image printed on the transfer sheet S passed through the transfer area 31, an in-line scanner 85 is disposed on the guide plate 39. The in-line scanner 85 reads a defective ejection nozzle detection chart to detect a defective ejection nozzle.

The defective ejection nozzle includes a nozzle completely clogged and thus unable to eject the recording liquid, a nozzle that ejects the recording liquid by an amount less than a specified amount, and a nozzle that ejects the recording liquid in a direction deviated from the correct ejection direction of the recording liquid, for example. That is, the defective ejection nozzle refers to a nozzle for which it is difficult to form a specified dot at a specified position.

An example of arrangement of the nozzles 61b will be described.

FIG. 2 is a diagram illustrating arrangement of the nozzles 61b in each of the heads 61Y, 61M, 61C, and 61BK of the image forming apparatus 100 illustrated in FIG. 1. As illustrated in FIG. 2, each of the heads 61Y, 61M, 61C, and 61BK includes nozzle plates 61a arranged side by side in lines with the plurality of nozzles 61b arranged in rows along the main scanning direction X. Further, in each of the heads 61Y, 61M, 61C, and 61BK, the thus-configured nozzle plates 61a are arranged in a plurality of rows, e.g., two rows, in a sub-scanning direction Y perpendicular to the main scanning direction X on a two-dimensional plane. For example, the nozzle plates 61a are arranged side by side in two rows such that the nozzle plates 61a in a front row (i.e., a row on the lower side in FIG. 2) and the nozzle plates 61a in a back row (i.e., a row on the upper side in FIG. 2) are arranged in a staggered fashion.

That is, as illustrated in FIG. 2, the two rows of nozzle plates 61a are arranged such that a plurality of nozzles 61b near a trailing end (i.e., an end on the right side in FIG. 2) of the leftmost nozzle plate 61a in the front row (i.e., the first nozzle plate 61a in the front row) overlap, in the sub-scanning direction Y, a plurality of nozzles 61b near a leading end (i.e., an end on the left side in FIG. 2) of the corresponding nozzle plate 61a in the back row (i.e., the first nozzle plate 61a in the back row). Further, the two rows of nozzle plates 61a are arranged such that a plurality of nozzles 61b near a trailing end of the first nozzle plate 61a in the back row overlap, in the sub-scanning direction Y, a plurality of nozzles 61b near a leading end of the second leftmost nozzle plate 61a in the front row (i.e., the second nozzle plate 61a in the front row), which is adjacent to the first nozzle plate 61a in the front row in the main scanning direction X.

In other words, when viewed in the sub-scanning direction Y, the nozzle plates 61a in the front and back rows are arranged such that the first nozzle plate 61a in the back row is seen in the gap between the first nozzle plate 61a in the front row and the second nozzle plate 61a in the front row adjacent thereto. Further, the first nozzle plate 61a in the back row is arranged such that, in a plurality of nozzles 61b thereof unseen in the gap, a plurality of nozzles 61b near the leading end of the first nozzle plate 61a in the back row overlap, in the sub-scanning direction Y, a trailing end portion of the first nozzle plate 61a in the front row. Further, the first nozzle plate 61a in the back row is arranged such that, in the plurality of nozzles 61b thereof unseen in the gap, a plurality of nozzles 61b near the trailing end of the first nozzle plate 61a in the back row overlap, in the sub-scanning direction Y, a leading end portion of the second nozzle plate 61a in the front row. With this configuration, the heads 61Y, 61M, 61C, and 61BK illustrated in FIG. 1 form a full-line inkjet head.

A system configuration of the image forming system of the embodiment will be described.

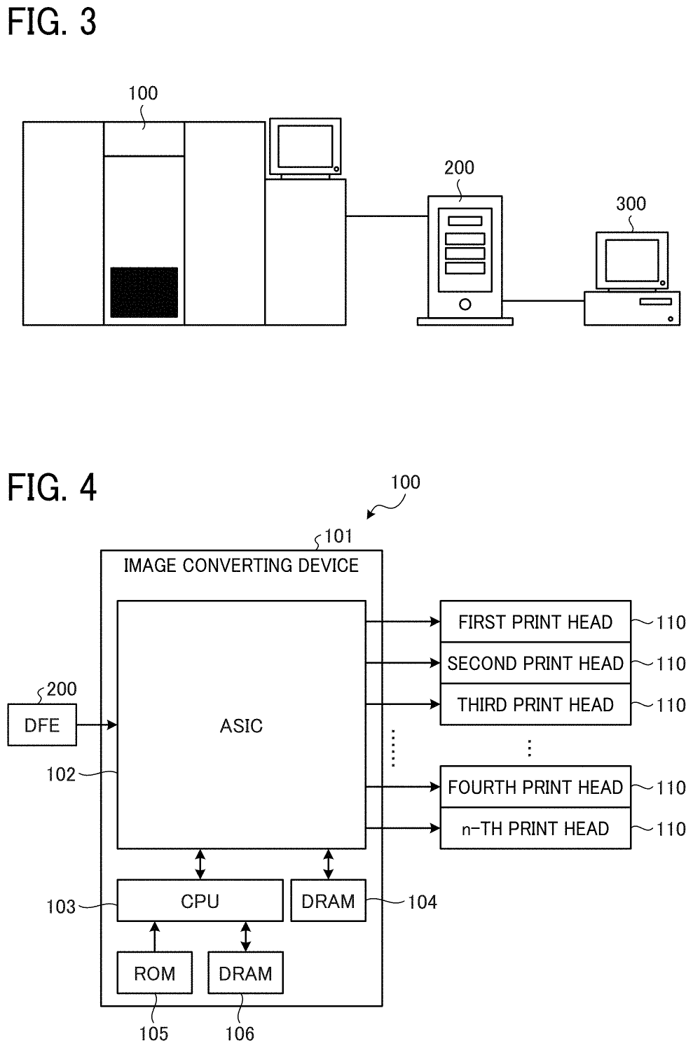

FIG. 3 is a system configuration diagram of the image forming system of the embodiment. In FIG. 3, a digital front end (DFE) device 200 is connected to a host apparatus 300 via a network such as a local area network (LAN), for example. The host apparatus 300 may be a computer capable of executing applications on various operating systems (OSs). When the host apparatus 300 transmits print data to the DFE device 200 in a format such as the page description language (PDL) format, the DFE device 200 renders and deploys the print data to convert the print data into raster data, and the image forming apparatus 100 executes printing based on the raster data. The DFE device 200 is an example of a data converting device.

A configuration of an image converting device of the image forming apparatus 100 will be described.

FIG. 4 is a block diagram of an image converting device 101 included in the image forming apparatus 100. The image converting device 101 converts image data transmitted from the DFE device 200 into data for each of print heads 110. The image converting device 101 illustrated in FIG. 4 is provided for each of the heads 61Y, 61M, 61C, and 61BK. The image converting device 101 converts the image data supplied by the DFE device 200 into data to be assigned to each of nozzles 61b of the print heads 110. Each of the print heads 110 illustrated in FIG. 4 is a combination of one of the nozzle plates 61a illustrated in FIG. 2 and the nozzles 61b included in the nozzle plate 61a. The print heads 110 is an example of a print head group.

The image converting device 101 includes an application specific integrated circuit (ASIC) 102, a central processing unit (CPU) 103, a dynamic random access memory (DRAM) 104, a read only memory (ROM) 105, and a DRAM 106.

The image data input from the DFE device 200 via a gateway, for example, is converted into image data for each of the print heads 110 by the ASIC 102, and is stored in the DRAM 104. After one page of image data is stored in the DRAM 104, the ASIC 102 reads the stored data from the DRAM 104, and supplies the read data to the print heads 110 as print data.

The CPU 103 executes control of the ASIC 102 related to data conversion settings and data transmission time. The CPU 103 is connected to the ROM 105 and the DRAM 106. The ROM 105 stores programs executed by the CPU 103, such as an image forming program, for example. The DRAM 106 is a memory used as a work area by the CPU 103. The CPU 103 and the ASIC 102 are an example of the ejection control unit.

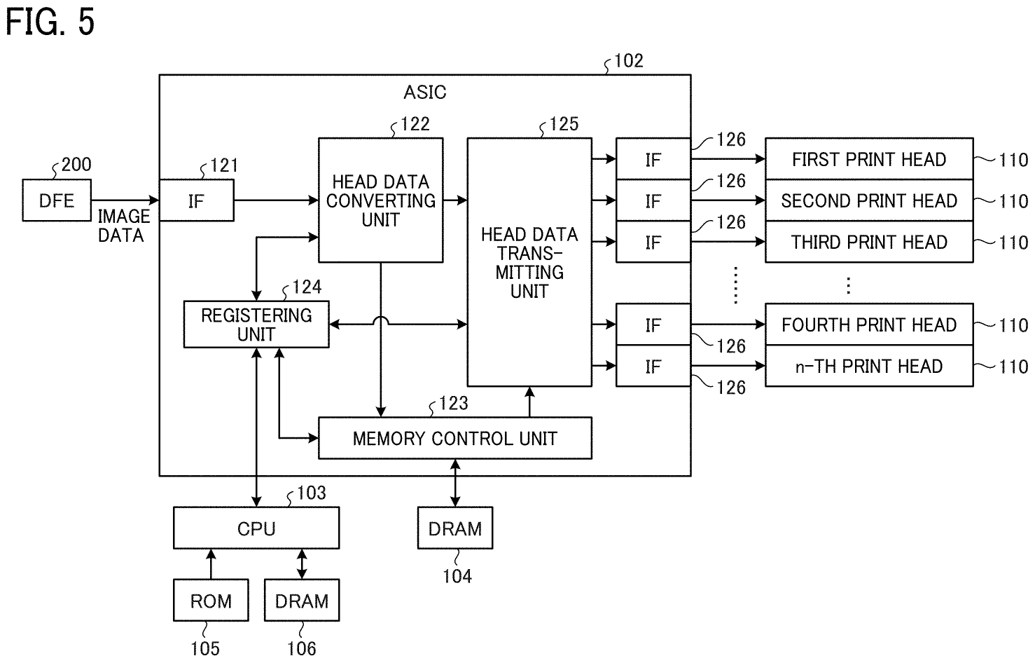

The CPU 103 operates based on the image forming program to perform ejection control to eject the recording liquid from the nozzles 61b of the print heads 110 in an area in which the print heads 110 do not overlap in the sub-scanning direction Y, as described in detail later. In an area in which the print heads 110 overlap in the sub-scanning direction Y, the CPU 103 selects an area in which the recording liquid is to be ejected. Then, the CPU 103 controls a head data converting unit 122 of the ASIC 102 in FIG. 5 to eject the recording liquid from one of the nozzles 61b adjacent to each other in the sub-scanning direction Y in the selected area.

Functions of the ASIC 102 will be described.

FIG. 5 is a functional block diagram of the ASIC 102. As illustrated in FIG. 5, the ASIC 102 includes an interface (I/F) 121, the head data converting unit 122, a memory control unit 123, a registering unit 124, a head data transmitting unit 125, and I/Fs 126. The I/Fs 121 and 126 may be Vx1 interfaces, for example. The ASIC 102 acquires the image data from the DFE device 200 via the I/F 121, and supplies the print data to the print heads 110 via the I/Fs 126. The head data converting unit 122 is an example of the print control unit.

The image data input from the DFE device 200 via the I/F 121 is subjected to a head data conversion process by the head data converting unit 122 to be converted into data corresponding to the respective positions of the nozzles 61b of the print heads 110, and is stored in the DRAM 104 by the memory control unit 123. In response to an instruction to start printing, the head data transmitting unit 125 accesses the DRAM 104 via the memory control unit 123, and reads the data assigned to the print heads 110. The data read from the DRAM 104 is supplied to the print heads 110 via the I/Fs 126. Operation settings of the above-described units are stored in the registering unit 124, which is accessed by the CPU 103. The above-described units operate based on setting values (i.e., ejection control data) stored in the registering unit 124 (i.e., a memory).

With the head data converting unit 122 included in the ASIC 102, a correction function for the defective ejection nozzle is implemented with a configuration reduced in size and cost.

A procedure of the head data conversion process will be described.

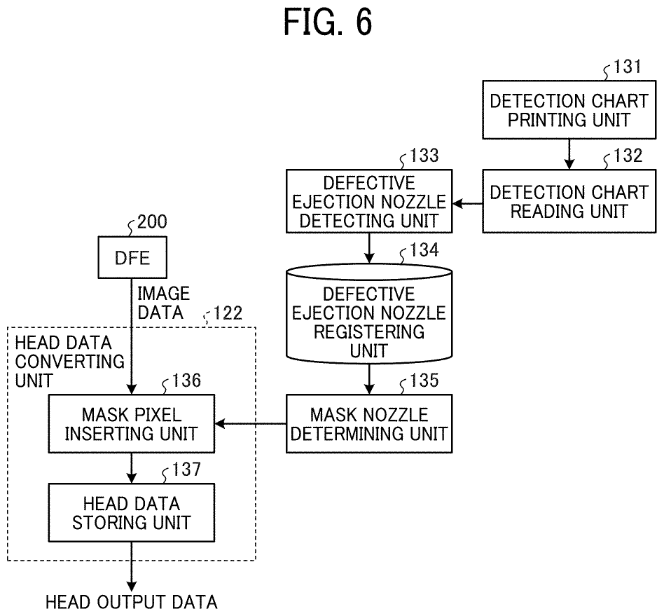

FIG. 6 is a schematic diagram illustrating a procedure of the head data conversion process based on defective ejection nozzle detection information. In FIG. 6, a detection chart printing unit 131 represents an image forming function of printing a detection chart on the transfer sheet S. The detection chart is an example of a defective ejection nozzle detection chart generated by the DFE device 200 to detect the defective ejection nozzle. The image forming function represented by the detection chart printing unit 131 is implemented by devices such as the heads 61Y, 61M, 61C, and 61BK, the transport device 10, and the intermediate transfer member 37.

A detection chart reading unit 132 corresponds to the in-line scanner 85 illustrated in FIG. 1. The detection chart reading unit 132 reads the detection chart printed on the transfer sheet S. Based on the read data of the detection chart, a defective ejection nozzle detecting unit 133 detects the defective ejection nozzle.

The defective ejection nozzle detection information representing the defective ejection nozzle detected by the defective ejection nozzle detecting unit 133 is registered in a defective ejection nozzle registering unit 134. A mask nozzle determining unit 135 determines the defective ejection nozzle represented by the defective ejection nozzle detection information registered in the defective ejection nozzle registering unit 134 as a mask nozzle that is to be stopped being driven. Then, the mask nozzle determining unit 135 supplies mask nozzle information of the mask nozzle to a mask pixel inserting unit 136 of the head data converting unit 122.

The defective ejection nozzle detecting unit 133 and the mask nozzle determining unit 135 are implemented by the controller 40 illustrated in FIG. 1, which includes the ASIC 102 and the CPU 103 illustrated in FIGS. 4 and 5. The detection of the defective ejection nozzle may be performed with a sensor. The defective ejection nozzle registering unit 134 is implemented by a memory.

The mask pixel inserting unit 136 of the head data converting unit 122 inserts, in the image data transmitted from the DFE device 200, a mask pixel for the pixel corresponding to the mask nozzle represented by the mask nozzle information transmitted from the mask nozzle determining unit 135. Thereby, head output data adjusted to the mask nozzle is generated for each of the print heads 110. The head output data is stored in a storage area of a head data storing unit 137 provided for each of the print heads 110.

The relationship between the mask nozzle and the data conversion by the head data converting unit 122 will be described.

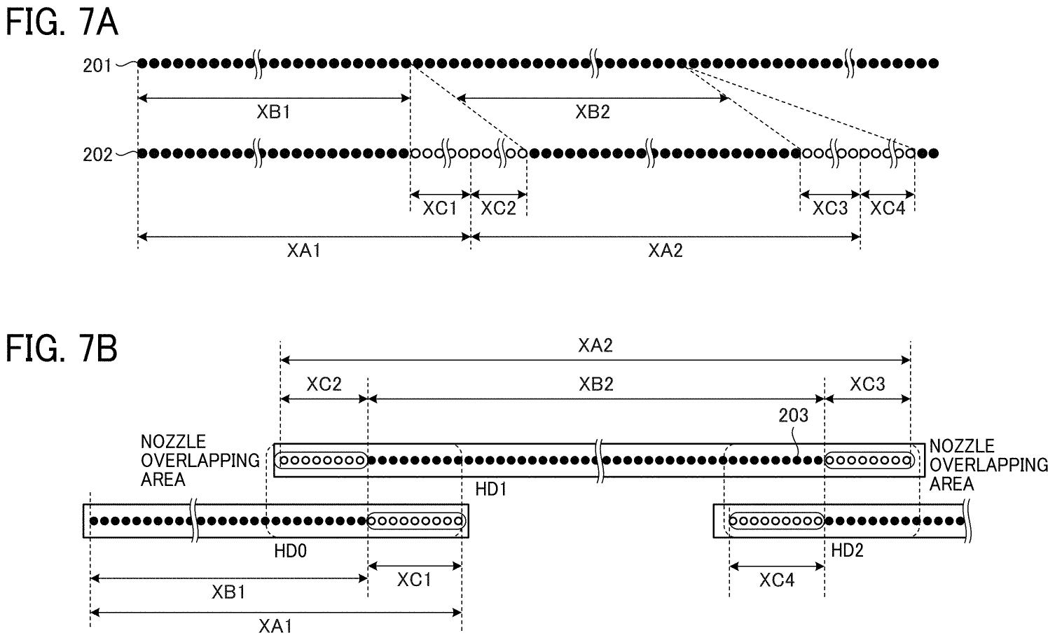

FIGS. 7A and 7B are diagrams illustrating the relationship between the mask nozzle and the data conversion by the head data converting unit 122. Black dots 201 in FIG. 7A represent pixel data items input to the head data converting unit 122, which are arranged along the main scanning direction X. Further, black dots 202 in FIG. 7A represent pixel data items resulting from the insertion of mask pixels by the head data converting unit 122.

In. FIG. 7A, a range XA1 corresponds to all nozzles of a zeroth print head HD0 illustrated in FIG. 7B. The range XA1 includes an input image in a range XB1 added with mask pixels in a range XC1. Further, in FIG. 7A, a range XA2 corresponds to all nozzles of a first print head HD1 illustrated in FIG. 7B. The range XA2 includes an input image in a range XB2 added with mask pixels in ranges XC2 and XC3. Herein, a mask pixel refers to a pixel assigned with zero as the density value and corresponding to a nozzle from which the recording liquid is not to be ejected. FIGS. 7A and 7B also illustrate a range XC4 adjacent to the range XC3.

FIG. 7B illustrates the relationship between the heads and the nozzles based on the pixel data illustrated in FIG. 7A. The nozzles may be arranged in one row, or may be arranged in multiple rows in a staggered fashion, for example. For ease of illustration, FIG. 7B illustrates the nozzles arranged in one row in printing order in each of the heads. Each of the heads is arranged such that the nozzles thereof partially overlap, in the sub-scanning direction Y, the nozzles of a head adjacent thereto. In an area in which two heads overlap in the sub-scanning direction Y, printing is performed with nozzles of one of the two heads but not with nozzles of the other one of the two heads. The pixels converted by the head data converting unit 122 are output as assigned to the nozzles of each of the heads. Thereby, the image data is printed with the area in the range XB1 and the area in the range XB2 joined together. Even if some of the nozzles overlap in the sub-scanning direction Y, therefore, the image data input from the DEE device 200 is normally printed.

An operation of generating the head output data will be described.

For an area in which two print heads 110 do not overlap in the sub-scanning direction Y, the head data converting unit 122 generates head output data for ejecting the recording liquid from the nozzles 61b of the two print heads 110. For an area in which two print heads 110 overlap in the sub-scanning direction Y and the nozzles 61b thereof are normal nozzles capable of normally ejecting the recording liquid, the head data converting unit 122 generates head output data for ejecting the recording liquid from the nozzles 61b of one of the two print heads 110. Further, if the defective ejection nozzle detecting unit 133 detects a defective ejection nozzle in the nozzles 61b of the two print heads 110 overlapping in the sub-scanning direction Y, the head data converting unit 122 stops the ejection of the recording liquid from the detected defective ejection nozzle. Further, the head data converting unit 122 generates head output data for executing printing by replacing the detected defective ejection nozzle with a normal nozzle 61b of a print head 110 adjacent in the sub-scanning direction Y to the print head 110 including the defective ejection nozzle, i.e., a normal nozzle 61b adjacent in the sub-scanning direction Y to the defective ejection nozzle.

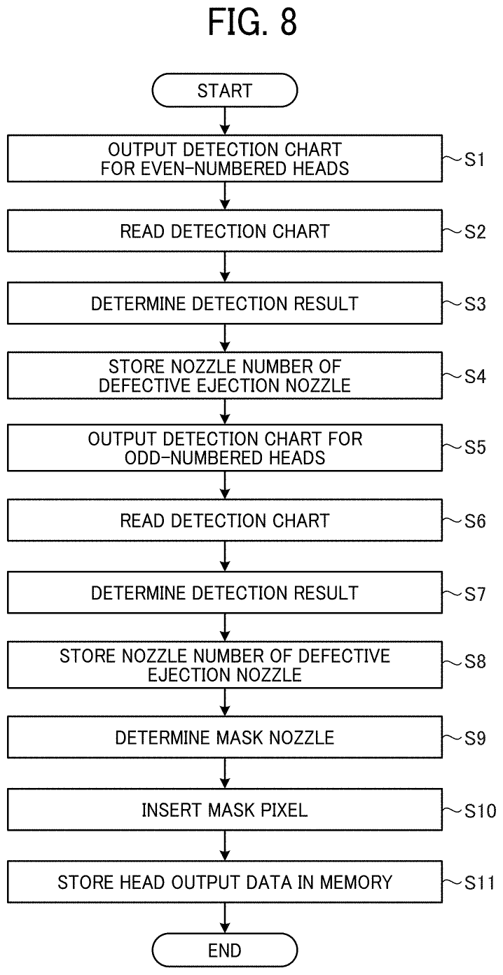

FIG. 8 is a flowchart illustrating a procedure of a process from the detection of the defective ejection nozzle to the generation of the head output data by the head data converting unit 122.

At step S1, the detection chart printing unit 131 outputs the detection chart for detecting the defective ejection nozzle in the even-numbered print heads 110. At step S2, the detection chart reading unit 132 reads the detection chart for detecting the defective ejection nozzle in the even-numbered print heads 110. At step S3, based on the read detection chart, the defective ejection nozzle detecting unit 133 detects the nozzle number of the defective ejection nozzle in the even-numbered print heads 110. That is, the defective ejection nozzle detecting unit 133 determines a detection result. At step S4, the detected nozzle number of the defective ejection nozzle in the even-numbered print heads 110 is stored in the defective ejection nozzle registering unit 134.

At step S5, the detection chart printing unit 131 outputs the detection chart for detecting the defective ejection nozzle in the odd-numbered print heads 110. At step S6, the detection chart reading unit 132 reads the detection chart for detecting the defective ejection nozzle in the odd-numbered print heads 110. At step S7, based on the read detection chart, the defective ejection nozzle detecting unit 133 detects the nozzle number of the defective ejection nozzle in the odd-numbered print heads 110. That is, the defective ejection nozzle detecting unit 133 determines a detection result. At step S8, the detected nozzle number of the defective ejection nozzle in the odd-numbered print heads 110 is stored in the defective ejection nozzle registering unit 134.

At step S9, in response to input of the image data from the DFE device 200, the mask nozzle determining unit 135 determines, based on information representing the nozzle number of the defective ejection nozzle stored in the defective ejection nozzle registering unit 134, the mask nozzle that is to be stopped ejecting the recording liquid. Then, the mask nozzle determining unit 135 transmits, to the mask pixel inserting unit 136 of the head data converting unit 122, the mask nozzle information representing the mask nozzle that is to be stopped ejecting the recording liquid. At step S10, the mask pixel inserting unit 136 inserts, in the image data transmitted from the DFE device 200, the mask pixel for the pixel corresponding to the mask nozzle represented by the transmitted mask nozzle information. Thereby, the head output data adjusted to the mask nozzle is generated for each of the print heads 110. At step S11, the mask pixel inserting unit 136 stores the head output data for each of the print heads 110 in the storage area of the head data storing unit 137.

The detection of the defective ejection nozzle is alternately performed between the even-numbered print heads 110 and the odd-numbered print heads 110, as described above. This is because, if the detection chart is output for all print heads 110 at the same time, it is difficult to detect defective ejection in the nozzles 61b included in an overlapping area of adjacent print heads 110.

The setting of the mask pixel according to the position of the defective ejection nozzle will be described.

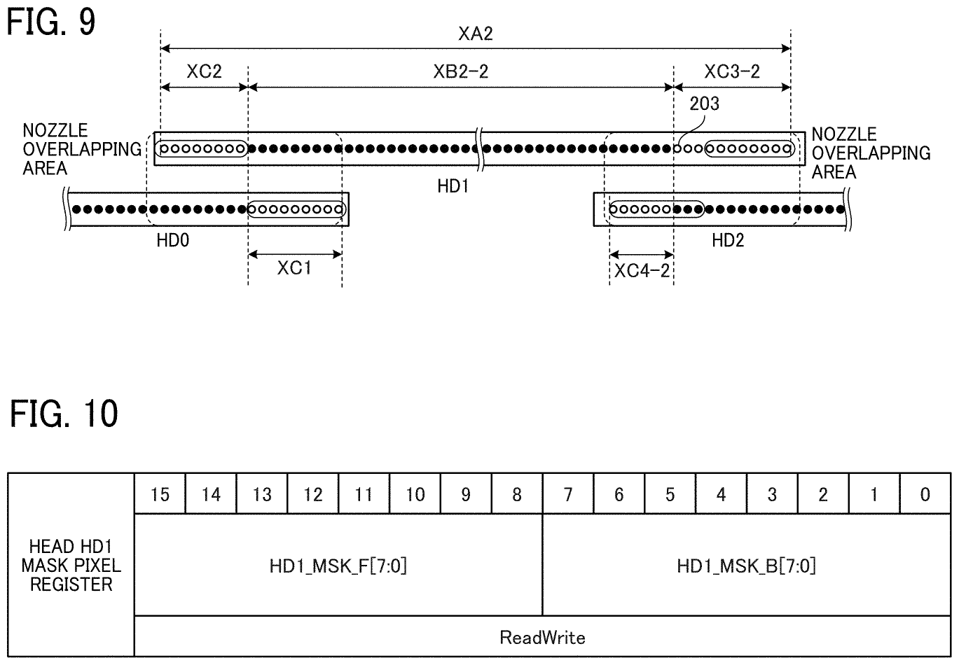

FIG. 9 is a diagram illustrating the setting of the mask pixel according to the position of the defective ejection nozzle. In the example of FIG. 7B, mask pixels are evenly assigned to overlapping areas of the print heads 110. For example, therefore, if a pixel 203 in FIG. 7B corresponds to the defective ejection nozzle, it is difficult to print the pixel 203.

Therefore, the defective ejection nozzle detecting unit 133 registers the nozzle for printing the pixel 203 as the defective ejection nozzle. As illustrated in FIG. 9, therefore, the head data converting unit 122 changes the masking position such that print the pixel 203 corresponding to the detective ejection nozzle of the first print head HD1 will be printed with a normal nozzle of the second print head HD2. Consequently, formation of a defective image due to the defective ejection nozzle is prevented.

The generation of the head data based on register setting values will be described.

FIG. 10 is a diagram illustrating the registering unit 124 that holds setting values of the mask pixels. The registering unit 124 of the ASIC 102 stores the setting values of the mask pixels for each of the print heads 110. The example of FIG. 10 illustrates the setting values of the first print head HD1. In FIG. 10, the value of HD1_MSK_F[7:0] represents setting of the number of mask pixels on the leading end side of the first print head HD1, and the value of HD1_MSK_B[7:0] represents setting of the number of mask pixels on the trailing end side of the first print head HD1.

In FIG. 9, the mask pixels on the leading end side of the first print head HD1 correspond to the range XC2, and the mask pixels on the trailing end side of the first print head HDI correspond to a range XC3-2. Thus, XC2 is set as the value of HD1_MSK_F[7:0], and XC3-2 is set as the value of HD1_MSK_B[7:0]. Based on the setting values of the mask pixels thus set in the registering unit 124, the head data converting unit 122 generates the head output data with the mask pixels inserted therein.

A modified example of the image forming system of the embodiment will be described.

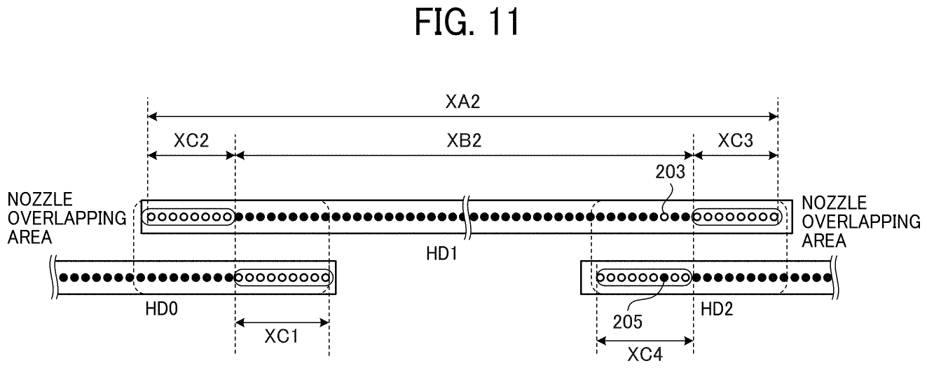

FIG. 11 is a diagram illustrating a modified example of the mask pixel setting of the embodiment according to the position of the defective ejection nozzle. In the example described above with FIG. 9, the correction for the defective ejection nozzle is performed with the increase or decrease in successive mask pixels.

In the modified example, on the other hand, the mask pixel is specifically assigned to the defective ejection nozzle, and the printing is performed with the corresponding nozzle 61b of the print head 110 overlapping the print head 110 including the defective ejection nozzle, to thereby perform the correction for the defective ejection nozzle. In the modified example, if a nozzle of the first print head HD1 for forming the pixel 203 in FIG. 11 is the defective ejection nozzle, for example, the head data converting unit 122 executes the head data conversion (i.e., assignment of pixel data to the nozzles) such that the pixel 203 is printed with a normal nozzle of the second print head HD2 overlapping the first print head HD1, i.e., the nozzle of the second print head HD2 for printing a pixel 205. Consequently, the pixel corresponding to the defective ejection nozzle is accurately corrected.

As understood from the foregoing description, in the image forming system of the embodiment, the print heads 110 for forming a sequence of pixels in the main scanning direction X are arranged to overlap in the sub-scanning direction Y. The print heads 110 are arranged to overlap in the sub-scanning direction Y such that pixels near a trailing end of one print head 110 in a front row overlap pixels near a leading end of the corresponding print head 110 in a back row, and that pixels near a trailing end of the print head 110 in the back row overlap pixels near a leading end of another print head 110 in the front row, i.e., the print head 110 adjacent in the main scanning direction X to the one print head 110 in the front row. Further, the mask setting is executed for the overlapping nozzles 61b of a print head 110 in the front row and a print head 110 in a back row such that the image data is not printed with two overlapping nozzles 61b at the same pixel position, i.e. such that the recording liquid is ejected from a nozzle 6th of one of the two print heads 110 but not from the corresponding nozzle 61b of the other one of the two print heads 110.

With this configuration, printing of the pixel corresponding to the defective ejection nozzle is corrected with a normal nozzle without entailing deviation of the nozzle ejection direction, for example. Consequently, the image data is printed with the same quality as that obtained during normal operation of the defective ejection nozzle (i.e., before the occurrence of defective ejection in the defective ejection nozzle). Accordingly, a high-quality image is formed despite the presence of the defective ejection nozzle.

Further, the head data converting unit 122 may generate head output data for executing the following ejection control. That is, for an area in which two print heads 110 do not overlap in the sub-scanning direction Y, the head data converting unit 122 may generate head output data for ejecting the recording liquid from the nozzles 61b of the two print heads 110. For an area in which two print heads 110 overlap in the sub-scanning direction Y, on the other hand, the head data converting unit 122 may select a recording liquid ejection area from the overlapping area in the sub-scanning direction Y, and may generate head output data for ejecting the recording liquid from one of nozzles 61b adjacent to each other in the sub-scanning direction Y in the selected recording liquid ejection area.

With this configuration, it is possible to avoid selecting the defective ejection nozzle when selecting the recording liquid ejection area from the overlapping area in the sub-scanning direction Y, and thereby to form a high-quality image with the normal nozzles 61b.

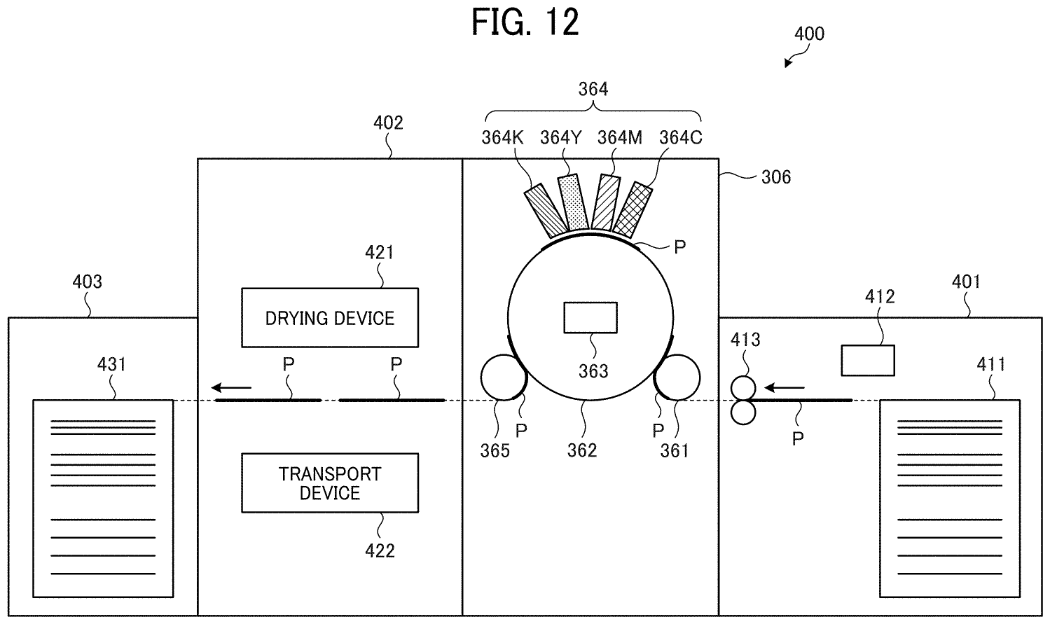

Next, a configuration of an image forming system is described according to another embodiment. The image forming apparatus 100 in the image forming system described above referring to FIG. 1 is implemented as an inkjet printer that transfers an intermediate image, formed on the intermediate transfer member 37, onto the transfer sheet S. The image forming apparatus 400 described below referring to FIG. 12 is an inkjet printer that forms an image by directly discharging ink, from one or more inkjet heads onto a recording sheet.

FIG. 12 is a sectional view of components of the image forming apparatus 400 according to this embodiment. As illustrated in FIG. 12, the image forming apparatus 400 includes a sheet feeding device 401, an image forming device 306, a drying device 402, and a sheet ejection device 403. The image forming device 306 forms an image onto a recording sheet P, which is an example of recording material, fed from the sheet feeding device 401, using ink as an example of liquid for image formation. The drying device 402 dries the ink adhered onto the recording sheet P. The sheet ejection device 403 then ejects the recording sheet P.

The sheet feeding device 401 includes one or more sheet trays 411 each having a stack of the recording sheets P mounted thereon, a sheet transfer device 412 that feeds the recording sheets P, one by one, from one of the sheet trays 411, and a pair of registration rollers 413 that transports the recording sheet P to the image forming device 306.

The sheet transfer device 412 may implement any desired device capable of transporting the recording sheet P, such as a roller or an air suction device. As a leading end of the recording sheet P, fed from the sheet tray 411 by the sheet feeding device 401, reaches a position where the registration rollers 413 are provided, the registration rollers 413 are driven at a predetermined time to transfer the recording sheet P to the image forming device 306. The sheet feeding device 401 may have a configuration other than the above-described configuration, as long as the sheet feeding device 401 is capable of transporting the recording sheet P.

The image forming device 306 includes a receiving roller 361, a sheet carrying drum 362, an ink discharge device 364, and a transferring roller 365. The receiving roller 361 transports the recording sheet P to the sheet carrying drum 362. The recording sheet P, which is held onto a circumferential surface of the sheet carrying drum 362, is transported to a position facing the ink discharge device 364. The ink discharging device 364 discharges ink onto the recording sheet P held by the sheet carrying drum 362. The transferring roller 365 transfers the recording sheet P having the ink thereon, from the sheet carrying drum 362 to the drying section 402.

Further, the receiving roller 361 is provided with a sheet gripper on its surface, which holds the leading end of the recording sheet P, which is transferred from the sheet feeding device 401 to the image forming device 306. The recording sheet P is then transported as the receiving roller 361 rotates. As the leading end of the recording sheet P reaches a position facing the sheet carrying drum 362, the recording sheet P is then carried by the sheet carrying drum 362.

Similarly, the sheet carrying drum 362 is provided with a sheet gripper on its surface, which holds the leading end of the recording sheet P. The sheet carrying drum 362 also has a plurality of holes that are dispersedly formed over its surface, each of which sucks air into the sheet carrying drum 362. The recording sheet P, carried by the sheet carrying drum 362, is held at its leading end by the sheet gripper, and sticked to the surface of the sheet carrying drum 362 by the suction air, such that the recording sheet P is transported as the sheet carrying drum 362 rotates.

The ink discharge device 364 discharges ink of four colors, i.e, cyan, magenta, yellow, and black, to form a color image directly on the recording sheet P. The ink discharge device 364 includes liquid discharge heads 3640, 364M, 364Y, and 364K, respectively, for cyan, magenta, yellow, and black ink. The liquid discharge heads 364C, 364M, 364Y, and 364K (collectively referred to as the head 364) may have any desired configuration. For example, the head 364 may be a head capable of discharging ink of metallic color, such as white, gold, or silver, or a head capable of discharging colorless ink that does not form an image, but used to coat a surface of the image.

The head 364 of the ink discharge device 364 controls discharging of ink according to a drive signal generated according to image information. As the recording sheet P, carried by the sheet carrying drum 362, passes an area facing the ink discharge device 364, the head 364 discharges ink of respective colors to form an image according to the image information. The image forming device 306 may have a configuration other than the above-described configuration, as long as the image forming device 306 is capable of forming an image using liquid.

As described above referring to FIGS. 2, 7, 9, and 11, in the image forming apparatus 400, a plurality of heads is arranged in a plurality of rows along the sub-scanning direction, with a print head in a first row of the plurality of rows overlapping, in the sub-scanning direction, a print head in a second row of the plurality of rows adjacent to the first row.

Specifically, the print heads for forming a sequence of pixels in the main scanning direction X are arranged to overlap in the sub-scanning direction Y. The print heads are arranged to overlap in the sub-scanning direction Y such that pixels near a trailing end of one print head in a front row overlap pixels near a leading end of the corresponding print head in a back row, and that pixels near a trailing end of the print head in the back row overlap pixels near a leading end of another print head in the front row, i.e., the print head adjacent in the main scanning direction X to the one print head in the front row. Further, the mask setting is executed for the overlapping nozzles of a print head in the front row and a print head in a back row such that the image data is not printed with two overlapping nozzles at the same pixel position, i.e. such that the recording liquid is ejected from a nozzle of one of the two print heads but not from the corresponding nozzle of the other one of the two print heads.

With this configuration, printing of the pixel corresponding to the detective ejection nozzle is corrected with a normal nozzle without entailing deviation of the nozzle ejection direction, for example. Consequently, the image data is printed with the same quality as that obtained during normal operation of the defective ejection nozzle (i.e., before the occurrence of defective ejection in the defective ejection nozzle). Accordingly, a high-quality image is formed despite the presence of the defective ejection nozzle.

The drying device 402 includes an ink drying device 421 (indicated as “drying device” in FIG. 12) that dries the ink adhered to the recording sheet P by the image forming device 306, and a transport device 422 that transports the recording sheet P from the image forming device 306.

The transport device 422 transports the recording sheet P, from the image forming device 306, to the ink drying device 421, and to the sheet ejection device 403. As the recording sheet P passes the ink drying device 421, the ink drying device 421 performs drying processing (for example, applying heat) such that liquid components, such as water components, of the ink on the recording sheet P evaporates, and the ink is fixed onto the recording sheet P. The drying processing that prevents curling of the recording sheet P is preferred.

The sheet ejection device 403 includes one or more sheet trays 431 each of which receives one or more recording sheets P. The recording sheets P, transferred from the drying device 402, are mounted on the sheet tray 431. The sheet ejection device 403 may have any desired configuration, as long as the sheet ejection device 403 is able to discharge the recording sheet P.

Referring to FIG. 12, the image forming apparatus 400 includes the sheet feeding device 401, image forming device 306, drying device 402, and sheet ejection device 403, but may additionally include any desired device. For example, the image forming apparatus 400 may further include a pre-processing device, between the sheet feeding device 401 and the image forming device 306, which performs pre-processing. Examples of pre-processing include, but not limited to, applying liquid that reacts with the ink to prevent the blur of ink. In another example, the image forming apparatus 400 may further include a post-processing device, between the drying device 402 and the sheet ejection device 403, which performs post-processing. Examples of post-processing include, but not limited to, binding the recording sheets P each having the image, correcting deformation of the recording sheet P, and cooling the recording sheet P. In another example, as the post-processing device, the image forming apparatus 400 may include a switch-back section that switches back the recording sheet having one side formed with the image, to the image forming device 306, to cause the image forming device 306 to form another image on another side of the recording sheet P in case duplex printing is performed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more circuits or circuitry. Circuitry includes a programmed processor, as a processor includes circuitry. A circuitry also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An image forming apparatus comprising:
a print head group including a plurality of print heads,
each of the plurality of print heads including a plurality of nozzles arranged along a main scanning direction, and
the plurality of print heads being arranged in a plurality of rows along a sub-scanning direction perpendicular to the main scanning direction, with a print head in a first row of the plurality of rows overlapping, in the sub-scanning direction, a print head in a second row of the plurality of rows adjacent to the first row; and
circuitry configured to
control the print head group to perform printing with at least one of the print head in the first row and the print head in the second row arranged along the sub-scanning direction,
control the print head group to eject recording liquid from a plurality of nozzles in a non-overlapping area of the print head in the first row and the print head in the second row not overlapping in the sub-scanning direction,
select a recording liquid ejection area from an overlapping area of the print head in the first row and the print head in the second row overlapping in the sub-scanning direction, and
control the print head group to eject the recording liquid from one nozzle of two adjacent nozzles adjacent to each other in the sub-scanning direction in the selected recording liquid ejection area.

2. The image forming apparatus of claim 1, wherein the circuitry selects, on a nozzle-by-nozzle basis, the recording liquid ejection area from the overlapping area of the print head in the first row and the print head in the second row overlapping in the sub-scanning direction.

3. The image forming apparatus of claim 1, wherein the circuitry is further configured to
based on a defective ejection nozzle detection chart printed with the print head group, detect a defective ejection nozzle with defective ejection of the recording liquid from the overlapping area of the print head in the first row and the print head in the second row overlapping in the sub-scanning direction,
stop ejection of the recording liquid from the detected defective ejection nozzle in the overlapping area of the print head in the first row and the print head in the second row overlapping in the sub-scanning direction, and
replace the detected defective ejection nozzle with a normal nozzle adjacent in the sub-scanning direction to the defective ejection nozzle to perform the printing, the normal nozzle being included in a print head of the plurality of print heads adjacent in the sub-scanning direction to another print head of the plurality of print heads including the defective ejection nozzle.

4. The image forming apparatus of claim 3, wherein for each of the plurality of nozzles detected as the defective ejection nozzle, the circuitry replaces the detected defective ejection nozzle with the normal nozzle.

5. The image forming apparatus of claim 1, wherein the circuitry is included in an application specific integrated circuit.

6. The image forming apparatus of claim I, further comprising a memory configured to store ejection control data generated by the circuitry to control ejection of the recording liquid from the plurality of nozzles in each of the plurality of print heads.

7. An image forming system comprising:
the image forming apparatus of claim 1; and
a data converting device configured to receive print data from an information processing device, convert the received print data into data in a data format compatible with the image forming apparatus, and supply the converted data to the image forming apparatus.

8. An image forming method of forming an image with a print head group including a plurality of print heads each including a plurality of nozzles arranged along a main scanning direction, the plurality of print heads being arranged in a plurality of rows along a sub-scanning direction perpendicular to the main scanning direction, with a print head in a first row of the plurality of rows overlapping, in the sub-scanning direction, a print head in a second row of the plurality of rows adjacent to the first row,
the image forming method comprising:
controlling the print head group to perform printing with at least one of the print head in the first row and the print head in the second row arranged along the sub-scanning direction;
controlling the print head group to eject recording liquid from a plurality of nozzles in a non-overlapping area of the print head in the first row and the print head in the second row not overlapping in the sub-scanning direction;
selecting a recording liquid ejection area from an overlapping area of the print head in the first row and the print head in the second row overlapping in the sub-scanning direction; and
controlling the print head group to eject the recording liquid from one nozzle of two adjacent nozzles adjacent to each other in the sub-scanning direction in the selected recording liquid ejection area.

9. A non-transitory recording medium storing a plurality of instructions which, when executed by one or more processors, cause the processors to perform an image forming method of forming an image with a print head group including a plurality of print heads each including a plurality of nozzles arranged along a main scanning direction, the plurality of print heads being arranged in a plurality of rows along a sub-scanning direction perpendicular to the main scanning direction, with a print head in a first row of the plurality of rows overlapping, in the sub-scanning direction, a print head in a second row of the plurality of rows adjacent to the first row,
the image forming method comprising:
controlling the print head group to perform printing with at least one of the print head in the first row and the print head in the second row arranged along the sub-scanning direction;
controlling the print head group to eject recording liquid from a plurality of nozzles in a non-overlapping area of the print head in the first row and the print head in the second row not overlapping in the sub-scanning direction,
selecting a recording liquid ejection area from an overlapping area of the print head in the first row and the print head in the second row overlapping in the sub-scanning direction, and
controlling the print head group to eject the recording liquid from one nozzle of two adjacent nozzles adjacent to each other in the sub-scanning direction in the selected recording liquid ejection area.
